(19) United States
(12) Patent Application Publication
(10) Pub. No.: US 2009/0098316 A1
(43) Pub. Date: Apr. 16, 2009

(54) Decorative upholstery tack

(76) Inventors: Bree Cox, Dana Point, CA (US); Kelli Brooks, Bend, OR (US)

Correspondence Address: LITMAN LAW OFFICES, LTD., POST OFFICE BOX 15035, CRYSTAL CITY STATION, ARLINGTON, VA, 22215-0035, US

(21) Appl. No.: 11/907,599

(22) Filed: Oct. 15, 2007

(51) Int. Cl. B44C 5/00

(52) U.S. Cl. 428/28

(57) ABSTRACT

The decorative upholstery tack provides a decorative or ornamental element installed upon or within the recessed head of the upholstery tack. The various decorative or ornamental elements serve to complement the finished appearance of an upholstered structure (e.g., chair, sofa, etc.) while simultaneously concealing the otherwise bare and unadorned head of the upholstery tack used to secure the upholstery to the underlying structure. The decorative or ornamental element may be permanently attached to the tack or removably and interchangeably attached to the tack, depending upon the specific mechanism and embodiment used.

### BACKGROUND OF THE INVENTION

1. Field of the Invention

The present invention relates generally to mechanical fasteners. More specifically, the present invention relates to a decorative upholstery tack having a decorative article (e.g., gemstone, etc.) installed in a recess in the head of the tack.

2. Description of the Related Art

There are many instances in which the head of a mechanical fastener (e.g., screw, nail, tack, etc.) remains exposed after installation in assembling the article in which it is used. Accordingly, various means have been developed in the past to either provide a less obtrusive fastener head, or a more decorative head.

In the case of less obtrusive heads, an example is the finishing nail with its extremely small head. Finishing nails are conventionally provided with very small recesses or indentations in the tops of their heads for placement of the point of a punch or the like therein for driving the head of the nail slightly below the surface of the structure. The resulting indentation is then filled with some material, and the surface is finished to conceal the location of the nail.

In the case of fasteners having larger and/or exposed heads, various means have been developed to provide a more attractive fastener head. One common means is to form the fastener from a bright metal capable of accepting or maintaining a high polish, e.g., stainless steel, brass, etc., with the head having a conventional configuration for driving into the structure during assembly.

The present inventors are aware of the following foreign references, which apparently describe fasteners having decorative or concealed heads:

German Patent No. 2,110,326, published on Sep. 16, 1971, illustrates an interconnected series of raised elements, each of which includes a fastener passage therethrough. Individual fasteners are driven through the passages to secure the elements to the underlying structure. Each fastener is provided with a cap having a convex exterior to conceal the fastener after installation. The interconnected elements may have integral, permanent interconnecting links, or may be formed with cooperating interconnecting attachment means.

Japanese Patent No. 9-313,233, published on Dec. 9, 1997, describes (according to the drawings and English abstract) a method of necking down the diameter of the hollow stem of a rivet or the like. The processed rivet is apparently used in the assembly of purse handles to purses, and similar manufacturing processes.

None of the above inventions and patents, taken either singly or in combination, is seen to describe the instant invention as claimed. Thus, a decorative upholstery tack solving the aforementioned problems is desired.

### SUMMARY OF THE INVENTION

The decorative upholstery tack comprises various embodiments of a tack having a head with an upper recess for accepting a decorative ornament therein. The recessed head may be formed integrally with an opposite tack stem portion, or may be formed as a separate element and secured to the upper end of the tack stem. Numerous configurations are disclosed herein, including different external shapes of the completed assembly, different mechanisms and means of securing the decorative element to the tack head and/or upper end of the stem of the tack, different decorative elements, etc.

These and other features of the present invention will become readily apparent upon further review of the following specification and drawings.

### BRIEF DESCRIPTION OF THE DRAWINGS

FIG. 1 is an environmental, perspective view of a first embodiment of a decorative upholstery tack according to the present invention.

FIG. 2 is an environmental, perspective view of a second embodiment of a decorative upholstery tack according to the present invention.

FIG. 3 is an environmental, perspective view of a third embodiment of a decorative upholstery tack according to the present invention.

FIG. 4 is an environmental, perspective view of a fourth embodiment of a decorative upholstery tack according to the present invention.

FIG. 5 is an exploded perspective view of a decorative upholstery tack, showing an ornament attached to the tack head adhesively.

FIG. 6 is an exploded perspective view of a decorative upholstery tack, showing an ornament attached to the tack head by a threaded fitting.

FIG. 7 is an exploded elevation view in section of a decorative upholstery tack, showing ornament attached to the tack head by a snap fastener.

FIG. 8 is an elevation view in section of a decorative upholstery tack, showing a setting tool used for deforming the periphery of the ornament setting for attachment of the ornament directly to the setting in the tack head for crimping.

FIG. 9 is an exploded perspective view of a decorative upholstery tack, showing an ornament attached to the tack head by a keyway and flange.

FIG. 10 is an exploded perspective view of a decorative upholstery tack, showing a recessed head ornament attachment wherein the head is separately attached to the remainder of the assembly.

Similar reference characters denote corresponding features consistently throughout the attached drawings.

### DETAILED DESCRIPTION OF THE PREFERRED EMBODIMENTS

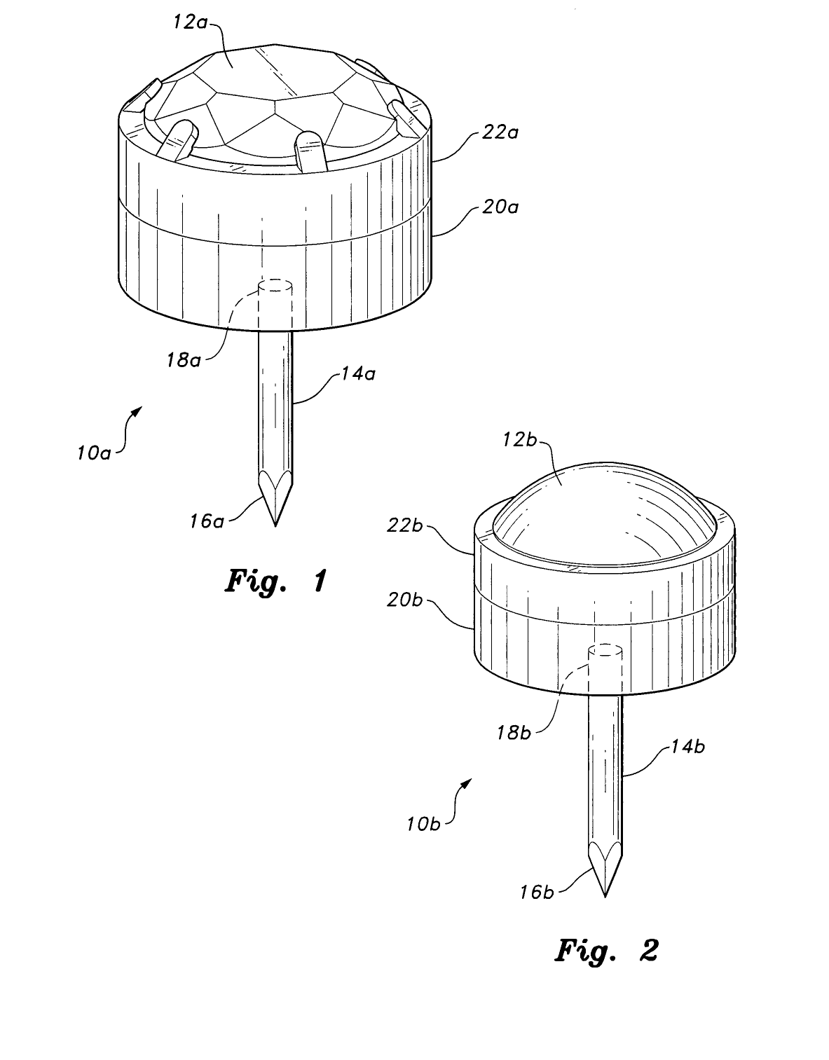

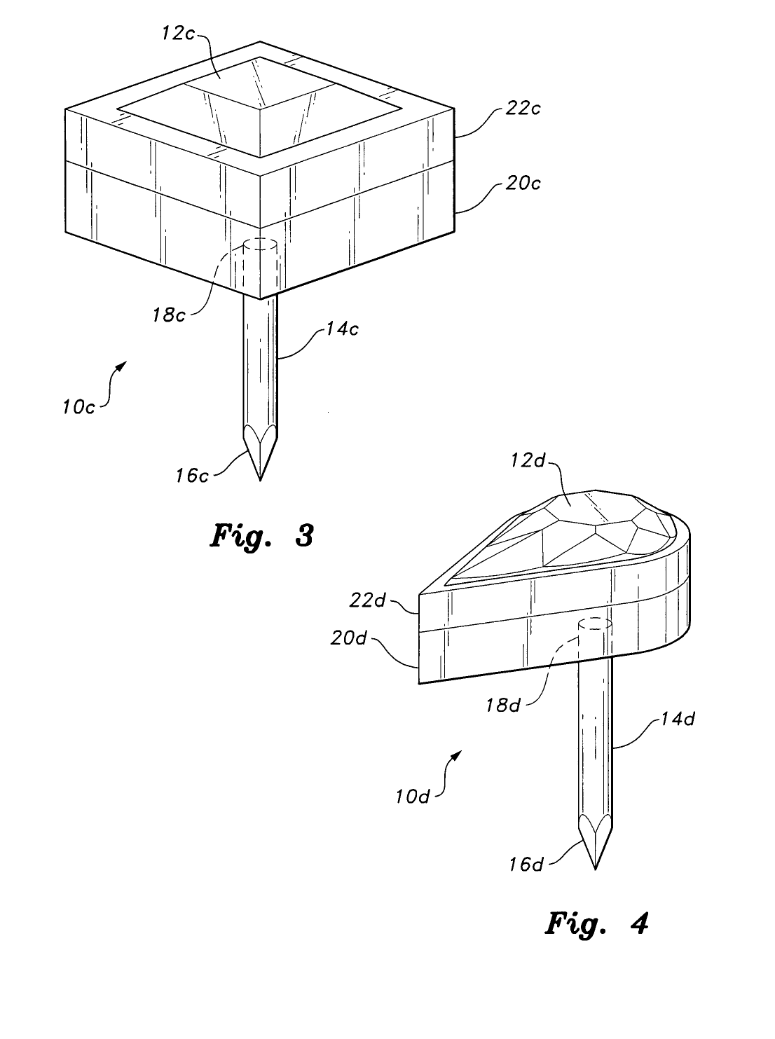

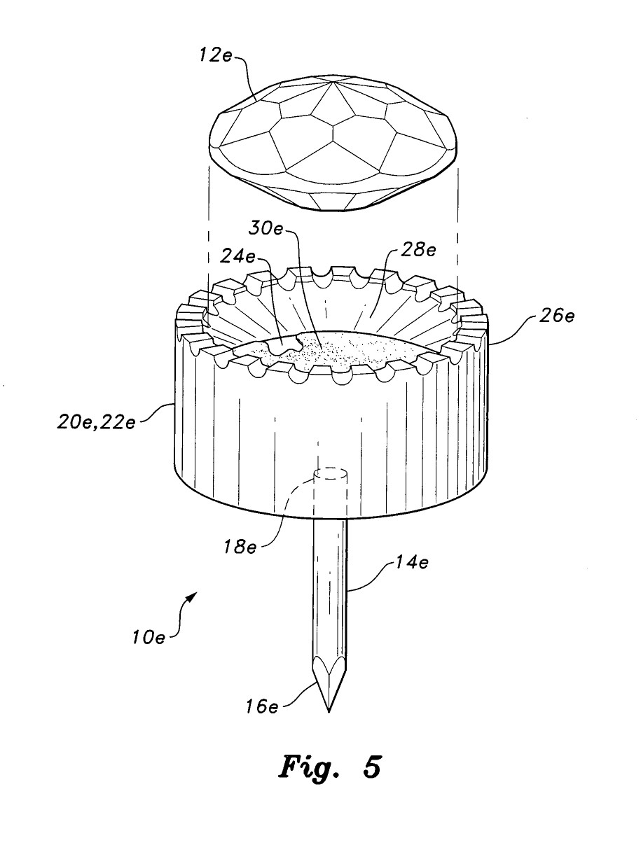

The present invention comprises a decorative upholstery tack illustrated by several examples in which the ornamental element may be permanently or removably affixed to the head of the tack, depending upon the specific configuration. FIGS. 1 through 4 are examples of completed or assembled decorative upholstery tacks, illustrating some of the myriad configurations possible. FIG. 1 is a perspective view of a decorative upholstery tack 10a having a top with a circular configuration having a faceted ornament 12a (e.g., a precious or semi-precious gemstone, etc.) secured atop the head of the tack. FIG. 2 illustrates a decorative upholstery tack 10b having a top with a circular configuration having a semi-spherical decorative ornament 12b thereatop, e.g., a pearlescent button of natural or synthetic pearl, a wood or plastic button, or the like. FIG. 3 is an illustration of a decorative upholstery tack 10c having a top with a square or rectangular configuration having a faceted ornament 12c set therein. FIG. 4 is a perspective view of a decorative upholstery tack 10d having a top with a teardrop shape having a faceted ornament 12d set therein.

Each of the tacks 10a through 10d includes an elongate tack stem 14a through 14d, respectively, having a sharpened end 16a through 16d, and an opposite head attachment end 18a through 18d, with a tack head 20a through 20d disposed upon the head attachment end of the tack stem and an ornamental setting 22a through 22d disposed upon the tack head. The various decorative upholstery tacks 10a through 10d of FIGS. 1 through 4 are exemplary, with it being understood that myriad additional configurations having various decorative or ornamental elements, shapes, sizes, materials, etc. are within the scope of the present invention.

FIG. 5 provides an exploded perspective view of a decorative upholstery tack 10e, illustrating one means of attaching the decorative ornament 12e to the tack. The tack 10e includes an ornament setting 22e formed integrally with the tack head 20e as a single, common, unitary structure, the head 20e extending from the head attachment end 18e of the tack stem 14e. The head and setting 20e, 22e have a closed base 24e which is devoid of any passages therethrough, with the base being surrounded by a periphery 26e defining an ornament receptacle 28e therein. The ornament receptacle 28e has an adhesive material 30e disposed therein (e.g., applied as a liquid or gel, double sided adhesive tape, etc.) for attachment of the ornament 12e to or within the head 20e and setting 22e. The raised periphery 26e may include some additional decorative embellishment, e.g., crenulations, as shown in FIG. 5.

The decorative tack 10e is preferably supplied without the decorative ornament 12e installed therein, enabling the tack 10e to be driven by means of a suitable tool (e.g., dowel, etc.) without damage to the ornamental element. The adhesive material 30e is then applied within the ornament receptacle 28e, and the ornament 12e is permanently affixed within the receptacle by means of the adhesive 30e.

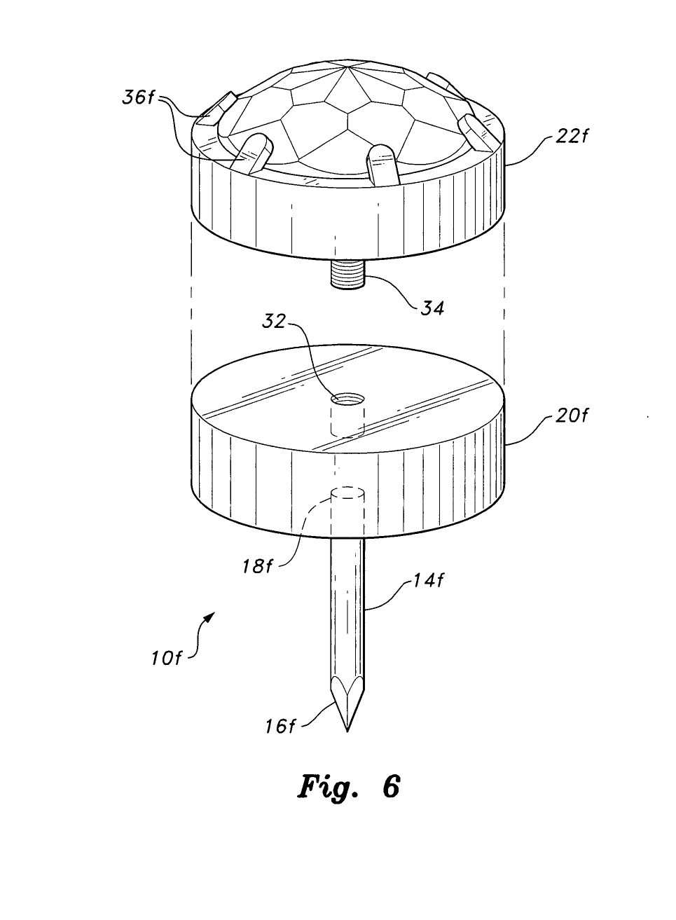

FIG. 6 is an exploded perspective view of another embodiment of a decorative upholstery tack 10f wherein the ornament setting is removably attached to the head by mating threaded elements. The lower portion of the decorative tack 10f is configured similar to the other embodiments of decorative upholstery tacks of the present invention, i.e., having a tack stem 14f with a sharpened end 16f and an opposite head or setting attachment end 18f. The tack head 20f and ornament setting 22f are separate components in the tack 10f of FIG. 5. The tack head 20f includes a central threaded blind hole or receptacle 32 therein, with the ornament setting 22f having a mating threaded post 34 depending centrally therefrom. This structure allows the setting 22f to be separated or removed from the head portion 20f to allow the tack stem 14f to be driven without damage to the setting and its ornament 12f. The ornament 12f is permanently and mechanically set into the setting 22f, e.g., by means of inwardly crimped fingers or prongs 36f. Alternatively, adhesive or a continuous peripheral bezel or other means may be used to secure the ornament 12f in its setting 22f. The completed ornament and ornament setting assembly may then be threaded onto the underlying head 20f, to complete the decorative upholstery tack 10f. This structure allows the ornament 12f and its setting 22f to be removed and interchanged for a different ornament and setting without removing the tack 14f from the structure with which it is used as a fastener, if such a change is ever desired.

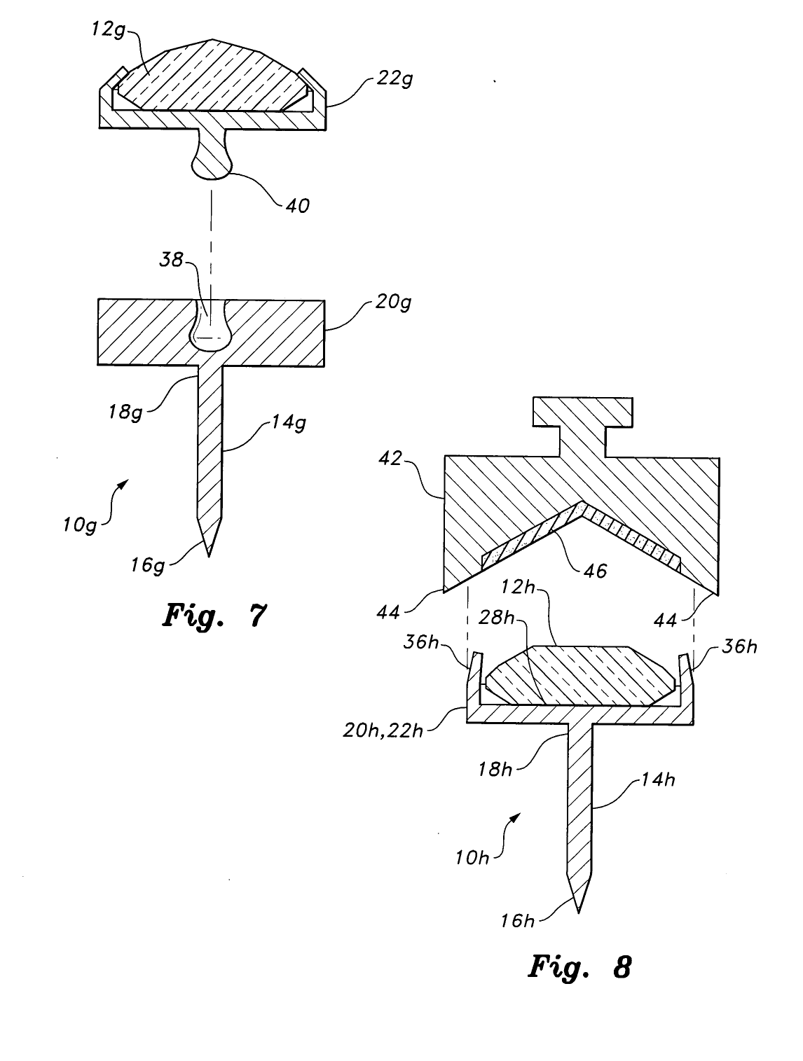

FIG. 7 is an exploded elevation view in section of another embodiment of the decorative upholstery tack, designated as decorative upholstery tack 10g. The tack 10g includes a tack stem 14g having a sharpened point 16g and opposite head attachment end 18g, with the tack head 20g extending therefrom and formed as a unitary, monolithic structure with the stem 14g. The head 20g includes female snap fastener fitting forming a setting attachment receptacle 38 therein, with the receptacle 38 having a relatively wide base and narrow neck. The setting 22g includes a male snap fastener or bulbed protrusion 40 extending therefrom, with the protrusion 40 fitting closely within the receptacle 38 of the tack head 20g when assembled therewith, in the manner of a snap fastener. The function is much the same as that of the decorative tack assembly 10f of FIG. 6, i.e., the setting 22g with its ornament 12g may be removed from the head 20g to allow the head and its stem 14g to be driven. The setting 22g and ornament 12g may then be snapped in place on the head 20g, with the snap attachment permitting interchangeability of the setting 22g and ornament 12g.

FIG. 8 is an elevation view in section of still another embodiment of a decorative upholstery tack 10h, with a setting tool shown in section therewith. The decorative tack 10h includes the head and ornament setting portions 20h and 22h as a single, unitary component, rather than as separate components, as in some other embodiments. The head and ornament setting 20h, 22h extend from the head attachment end 18h of the tack stem 14h, with the ornament 12h seated in the receptacle 28h of the combined head and ornament setting. The ornament 12h is mechanically secured within the setting by hammering or crimping the retaining prongs 36h over the edges of the ornament 12h using the setting tool 42. The setting tool 42 includes a hard periphery 44 to crimp the ornament retaining prongs 36h over the edges of the ornament 12h, and a central cushion 46 to avoid damage to the ornament 12h should the central area of the setting tool 42 contact the ornament 12h. The ornament 12h is permanently attached or secured to the remainder of the tack assembly 10h in this embodiment, and cannot be readily removed therefrom.

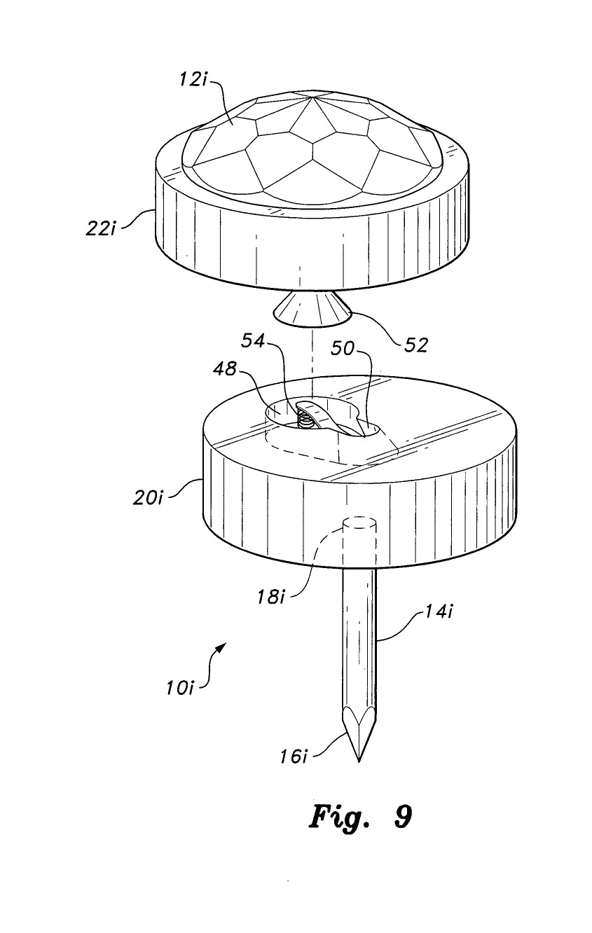

FIG. 9 illustrates an exploded perspective view of yet another embodiment 10i of the decorative upholstery tack, in which the tack head 20i includes a keyhole-shaped receptacle therein for accepting a mating fitting depending from the bottom of the ornament setting portion 22i. The head 20i is attached to the head attachment end 18i of the tack stem 14i, as in other embodiments. In this case, the head 20i has a relatively larger diameter, laterally offset receptacle portion 48, with a slot 50 extending therefrom. The slot is relatively narrower at its top, i.e., at the surface of the head 20i, but is undercut in a conical form, widening to a diameter at its floor equal to that of the constant diameter of the laterally offset receptacle portion 48. The ornament setting 22i includes a conical stud 52 depending therefrom, with its minor diameter forming the attachment to the underside of the ornament setting 22i and its major diameter spaced away from the underside of the ornament setting. The stud 52 of the ornament setting 22i is inserted into the larger diameter offset portion 48 of the receptacle, and slid toward the center of the head 20i into the narrower slot portion 50. The wider inner portion of the slot is dimensioned to accept the major diameter of the conical protrusion 52 of the ornament setting 22i, while the narrower upper edge of the slot fits closely about the narrower neck of the stud 52 to prevent the ornament setting 22i from pulling directly out from the tack head 20i. A retaining leaf and spring assembly 54 may be installed within the receptacle to bear against the conical protrusion 52 of the ornament setting 22i when installed to hold the setting in place.

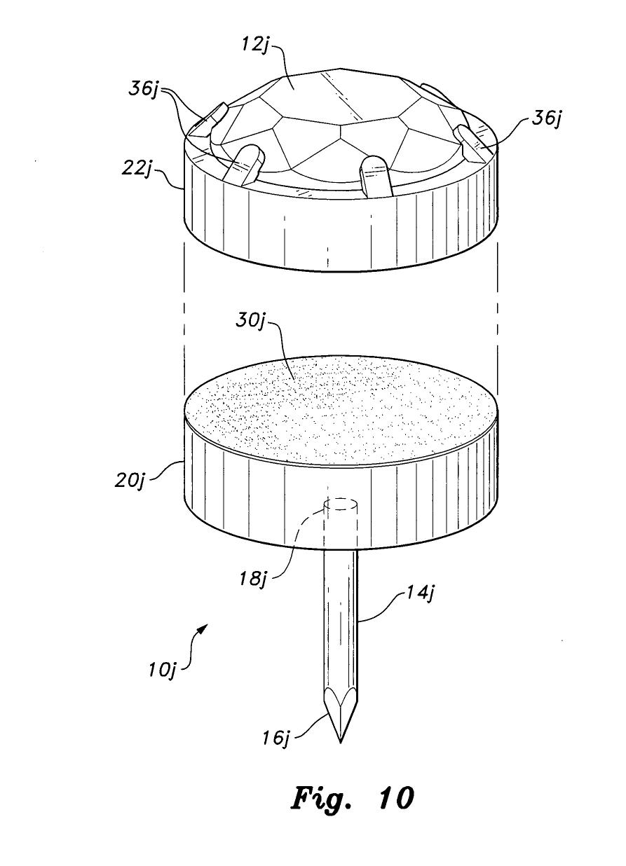

FIG. 10 illustrates yet another embodiment of the decorative upholstery tack 10j, using an adhesive to secure the head and setting portions to one another. The tack 10j is configured generally like the other tacks of the present invention, i.e., having a tack stem 14j with a sharpened point 16j and opposite head attachment end 18j, with the head 20j mounted atop the attachment end of the tack stem 14j. The ornament setting 22j secures an ornament 12j therein, e.g., by means of setting prongs 36j or other suitable means as described herein. The tack stem 14j and head 20j are driven into the material for installation before the setting 22j and its ornament 12j are installed upon the head. The setting 22j is secured permanently to the head 20j by an adhesive material 30j (e.g., liquid or gel coating, double-sided tape, etc.) applied to the top of the head 20j and/or to the underside of the setting 22j. The head and setting are permanently bonded together by the adhesive 30j, when assembled.

In conclusion, the various embodiments of the decorative upholstery tack permit secure attachment of the tack to the upholstery while providing a decorative head simulating a gemstone, which may be either permanently or removably and interchangeably attached to the tack head.

It is to be understood that the present invention is not limited to the embodiments described above, but encompasses any and all embodiments within the scope of the following claims.

1-20. (canceled)

21. A decorative upholstery tack, consisting of:
a tack head having an upper surface and a lower surface;
an elongated tack stem having an attachment end and an opposite sharpened end, the attachment end is centrally attached to the lower surface of the tack head, wherein the lower surface of the tack head and the elongated tack stem form a T-shaped structure;
an ornament setting removably attached upon the upper surface of the tack head, the ornament setting having a closed base devoid of passages therethrough and a raised periphery, the base and periphery defining an ornament setting receptacle therein; and
an ornament disposed within the ornament setting receptacle.

22. The decorative upholstery tack according to claim 21, wherein the ornament setting is mechanically attached to the upper surface of the tack head.

23. The decorative upholstery tack according to claim 22, wherein the ornament setting is attached to the upper surface of the tack head by a threaded fitting.

24. The decorative upholstery tack according to claim 22, wherein the ornament setting is attached to the upper surface of the tack head by a snap fastener.

25. The decorative upholstery tack according to claim 22, wherein the ornament setting is attached to the upper surface of the tack head by a keyway/stud fitting.

26. The decorative upholstery tack according to claim 21, wherein the ornament setting and the tack head each has a circular configuration.

27. The decorative upholstery tack according to claim 21, wherein the ornament setting and the tack head each has a rectangular configuration.

28. The decorative upholstery tack according to claim 21, wherein the ornament setting and the tack head each has a teardrop shape.
